(19) United States
(12) Patent Application Publication
(10) Pub. No.: US 2007/0200876 A1
(43) Pub. Date: Aug. 30, 2007

(54) Compact Disk Printing Equipment

(76) Inventors: Alain Rousseau, Herblay (FR); Florent Boivin, Sable/Sarthe (FR)

Correspondence Address: BUCHANAN, INGERSOLL & ROONEY PC, POST OFFICE BOX 1404, ALEXANDRIA, VA, 22313-1404, US

(21) Appl. No.: 11/579,620

(22) PCT Filed: May 4, 2005
(86) PCT No.: PCT/FR05/01131

§ 371 Date: Nov. 6, 2006

(30) Foreign Application Priority Data
May 5, 2004 (FR) 0404825

(51) Int. Cl. B41J 2/01

(52) U.S. Cl. 347/1

(57) ABSTRACT

Compact disk printing equipment The invention relates to equipment for printing information on the surface of a compact disk. The printing equipment is of the type having at least one movable print head and an object carriage (C) and at least one main drive motor (MI), and also an additional motor (MII) driving the carriage (C) through part of its movement, and a mechanical switch (A) for switching the carriage drive alternately between the main motor (MI) and the additional motor (MII). Application to simple ink-jet printers for compact disks.

The present invention relates in a general way to equipment for printing on objects such as various magnetic or digital recording media, and more specifically to equipment for printing a text and/or images on one surface of a compact disk such as a CD-ROM or a digital versatile disk.

### BACKGROUND OF THE INVENTION

Various types of compact disks, such as CD-ROMS, including readable (CD-R) or writeable (CD-RW) types, and digital versatile disks (DVD, DVD-R, DVD-RW), are currently used for recording data or information in digital form, such as texts, images, audio-visual data, etc. These data vary from one disk to another, and it is frequently necessary to be able to identify the disk according to the information recorded on it. For this purpose, a disk generally has a label on the central part of at least one of its two surfaces, on which it is possible to write manually or mechanically to identify it. Depending on the type of medium, it may also be possible to apply information in the form of text or graphics directly to one or other of the surfaces of the disk.

For producing long runs of identical disks, each carrying the same information and each therefore receiving the same label or the same identifying information, use is frequently made of a screen printing method, using suitable industrial machinery. However, these methods are unsuitable for short print runs, and are therefore also unsuitable for one-off printing operations, particularly when the user wishes to print different customized information on each disk.

There are various known systems for printing information on the surfaces of compact disks. For example, patent FR 2,844,744 describes a system for sorting and burning a set of disks and also for printing information on one of the surfaces of each disk, in which each disk is carried between the different locations for blank disks, for printing and for recording information on the disks, the disks being carried from one location to another by a disk transport carriage. Systems of this type are relatively complicated and are intended for processing relatively large numbers of disks.

A device for recording data on a compact disk and for printing information on the surface of the disk is described in application WO 03102944. This device includes a disk recording or copying unit and a unit for printing on a surface of the disk, these two units being mounted on the same shaft perpendicular to a disk carriage combined with an arm used for handling the disk. Patent EP 1057651 describes a simple and economical printer comprising an object carrier which is adaptable to a plurality of object shapes. U.S. Pat. 6,302,601 relates to a printer of the thermal transfer type adapted for printing on compact disks and comprising a removable support.

Other devices intended for one-off use have been proposed on the basis of printers, for example inkjet printers, which are relatively simple and inexpensive, modified and adapted to receive disks in place of sheets of paper.

The compact disk printing equipment according to the present invention belongs to this category, and provides a printer capable of printing various kinds of information on a one-off customized basis on the surface of a compact disk, by using an inexpensive additional device which adapts the operation of a standard printer so that it can print on a surface of a medium such as a compact disk.

### SUMMARY OF THE INVENTION

The printing equipment according to the present invention is based on a conventional standard printer, of the inkjet type for example, intended for printing on sheets of paper, having at least one motor for driving the print head and the support of the object to be printed, and completed by an additional motor and a mechanical switching device to drive the support by means of one or the other motor. As a general rule, ordinary printers have two separate motors to move the print head and to advance the paper receiving the impression.

Thus the equipment for printing information on the surface of an object such as a compact disk according to the present invention is of the type having at least one movable print head and an object carriage and at least one main drive motor, and is distinguished in that it has an additional motor driving the carriage through part of its movement, and a mechanical switch for switching the carriage drive alternately between the main motor and the additional motor.

The invention also relates to a method for printing information on the surface of an object such as a compact disk, by means of equipment of the type having at least one movable print head and an object carriage and at least one main drive motor, in which method the object to be printed is placed on the carriage, the carriage is advanced by means of an additional motor to a start of print position, the carriage is advanced by the main motor during printing, and the carriage is returned to its initial position by the additional motor, after removal of the printed disk. The additional motor control system is preferably programmed to extend the movement of the carriage to a position where it is possible to remove the printed disk. In a variant, the carriage is kept in its final position corresponding to the removal of the printed disk until a new print command is given, causing the carriage to return to the starting position. In another variant, the printed disk can be removed after the carriage has returned to the starting position.

The equipment for printing on a recording medium according to the present invention is designed so as to use a base consisting of a standard printer and to supplement this with an appropriate device, care being taken to modify its original operating mode as little as possible. Thus it is desirable that the program and electronic components which control the movements of the print head and of the support of the object to be printed, generally a sheet of paper, should not be modified in respect of either their design or their operating mode, and that the additional device fitted to the equipment should not disturb their operation, in order that the printing on the surface of the recording medium, such as a compact disk, take place exactly in the same way as printing on a sheet of paper in the same printer without modification.

According to one characteristic of the invention, the recording medium on one of whose surfaces the texts or graphics are to be printed consists of a carriage which can move in both directions along an axis substantially perpendicular to the axis of movement of the print head, unlike the print support of an ordinary printer which moves between two positions, always in the same direction. In an ordinary printer, this support generally consists of rollers and guides which guide the movement of the sheet of paper from a loading tray to a collecting tray after printing.

More specifically, according to the present invention, it must be possible to control the movement of the compact disk carriage alternately by the printer control system and by the control system of the additional device, and the carriage is then driven either by the printer motor or by the motor of the additional device, depending on the position of the mechanical switch.

Additionally, the movement of the carriage is controlled in such a way that it returns to its starting position after each compact disk has been printed, so as to be ready for the printing of the next compact disk. Thus the movement of the carriage is determined by the printing cycle during only one part of its cycle. When the carriage is driven by the motor of the printer, the mechanical switch then being in the appropriate position, the print head of the printer moves substantially perpendicularly to the axis of movement of the carriage, under the control of the printer control electronics and software, in order to print the desired information on the surface of the compact disk, as in the case of ordinary printing on a sheet of paper. On completion of this printing, in other words at the end of the print cycle, the motor of the additional device again drives the movement of the carriage, owing to the operation of the mechanical switch. This end of the print cycle can advantageously be detected by a sensor, such as a photoelectric cell, which identifies the corresponding position of the carriage.

The mechanical switch preferably consists of a gear system which can pivot between two positions so as to be driven alternately by the pinions of one or other of the two motors. In a preferred embodiment, the mechanical switch comprises a right-angle mounted gearing including a gear wheel on the compact disk carriage drive shaft, interacting with an intermediate pinion mounted on an arm pivoting about the shaft of the gear wheel. Thus the pivoting of the arm about its axis brings the intermediate pinion alternately into contact with one and the other of the two driving pinions.

When the mechanical switch is actuated to switch from one position to the other, the tip of a tooth of the driving pinion may be located opposite the tip of a tooth of the intermediate pinion. To prevent the incorrect drive of the latter, the movement of the mechanical switch is controlled by an actuator, and a spring is placed between the actuator and the switch in order to compensate for the angular variation created in this way. Thus, as soon as the driving pinion starts to rotate, the intermediate pinion is placed in position by the action of the spring, and the two pinions engage correctly.

In a variant of the invention, the link between the actuator and the switch is fixed, but the shaft of the intermediate pinion is mounted so as to be slidable in a direction substantially perpendicular to the longitudinal axis of the pivoting arm, against the action of a spring which pushes it back against the driving pinion. Thus, when two teeth of the intermediate pinion and a driving pinion are positioned facing each other, the shaft of the intermediate pinion is automatically withdrawn through a distance equal to the depth of the toothing, and, as soon as the driving pinion starts to rotate, the intermediate pinion is placed in position and the two pinions engage correctly.

The device according to the present invention also has the advantage of not disturbing the print head cleaning mode, which is necessary for maintaining the quality of printing on the compact disks or on paper as appropriate.

Thus, in a known method, the print heads can be cleaned by means of a pump, which can be actuated by the same motor that drives the paper or the compact disk carriage. Consequently, in such a configuration, the print head cleaning cannot be carried out during a print cycle, but must take place outside this cycle, at an instant determined by the printer program according to its own parameters.

The device according to the invention makes it possible to avoid disturbing the process of cleaning the print heads with the pump actuated by the printer motor outside the print cycle, owing to the mechanical switch which enables the printer motor to be isolated on completion of the printing, and to drive the compact disk carriage by means of the additional motor.

The equipment according to the invention comprises a main motor movement sensor, connected to a control circuit enabling the additional motor to run when the sensor has detected that the main motor is stationary. Thus the two motors are synchronized by the movement sensor which enables the additional motor control circuit to know whether the printer motor is on or off, and to activate the additional motor only when the printer motor is stationary.

The printer according to the invention has the advantage of being usable in manual mode or as part of an automated device. In the case of manual operation, the user directly loads each disk and removes it after printing. In an automated mode, the printer is incorporated into a system including, in a known way, devices for automatically loading and removing the disks.

### BRIEF DESCRIPTION OF THE DRAWINGS

The characteristics and advantages of the present invention will be made clearer by the following description of a preferred and non-restrictive embodiment, referring to the attached drawings, in which:

FIG. 1 is a schematic view showing the organization of the device according to the invention.

FIG. 2 is a perspective view of the mechanism for switching the carriage drive from one system to the other.

FIG. 3 is a view of the switching device for providing the engagement of the additional motor pinion.

FIG. 4 is a view of the switching device in the position in which the disk carriage is driven by the printer motor.

FIG. 1 shows schematically the operation of a device according to the invention, combined with a paper drive and print head control system of an ordinary inkjet printer.

### DETAILED DESCRIPTION OF THE PREFERRED EMBODIMENTS

The motor (MI) is the printer motor which drives the movement of the carriage (C). The operation of the motor (MI) is controlled by the Control I circuit. A mechanical switch (A) is placed between the motor (MI) and the compact disk carriage (C) in such a way that the movement of the carriage (C) is driven by the motor (MI) when the switch (A) is switched to the corresponding engagement position.

The additional motor (MII) can also drive the carriage (C) via the mechanical switch (A) when the latter is in the appropriate position. The operation of the additional motor (MII) is controlled by the Control (II) circuit.

The mechanical switch (A) is switched by the Control (II) circuit in response to the parameters received from the movement sensor (B), according to a simple logic. The movement sensor (B) is of an ordinary type, which detects whether the motor (MI) is rotating or stationary.

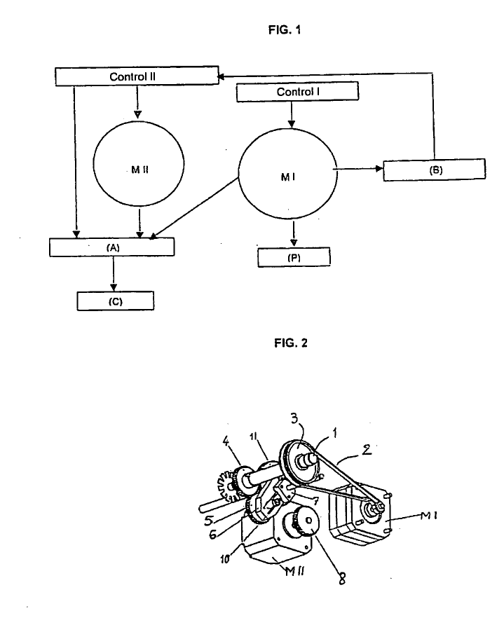

The printer motor (MI) can also drive the pump (P) serving to clean the print heads of the printer. FIG. 2 shows the relative positions of the two motors (MI) and (MII) and of the mechanical switch (A).

As shown in this figure, the printer motor (MI) drives the shaft (1) by means of the belt (2) and the wheel (3). The shaft (1) carries the pinion (4) whose rotation drives the intermediate pinion (5) mounted on the pivoting arm (6) of the mechanical switch (A).

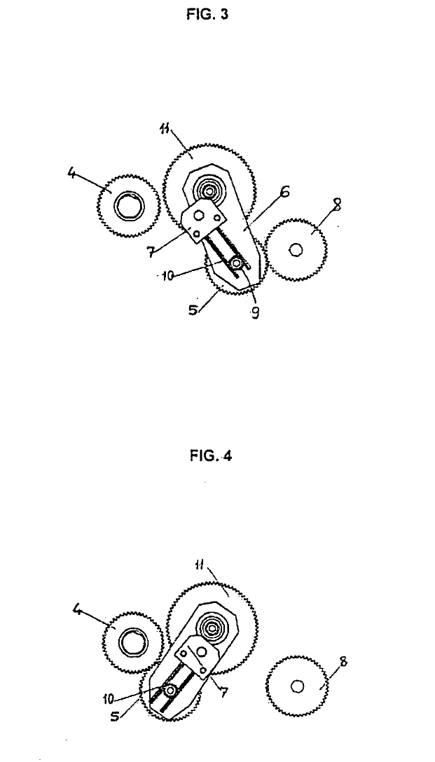

The angular rotary movement of the switch (C) is provided by an actuator (7) by means of a mechanism shown in greater detail in FIG. 3. Under the action of the actuator (7), the mechanical switch (A) is moved through an angle such that the intermediate pinion (5) comes into contact with the pinion (8) of the motor (MII).

FIG. 3 shows the mechanical switch (A) in the position in which it is switched toward the additional motor (MII), the intermediate pinion (5) engaging with the drive pinion (8). The actuator (7) acts on the head of the shaft (9) carrying the intermediate pinion (5) by means of a spring (10) with two flexible blades, one on each side of the shaft (9). The flexibility of one or other of the two blades of the spring (10) therefore compensates for the angular offset occurring when the toothing of the intermediate pinion (5) faces the toothing of the drive pinion (8), with the two teeth of each pinion in contact at their tips. As soon as the drive pinion (8) starts to turn, its toothing becomes correctly engaged with that of the intermediate pinion (5), which in turn drives the gear wheel (11) for driving the carriage (C).

FIG. 4 shows the symmetrical position in which the mechanical switch (A) is switched, by the actuator (7), against the drive pinion (4) of the printer motor (MI).

1. Equipment for printing information on the surface of an object comprising at least one movable print head and an object carriage (C) and at least one main drive motor (MI), wherein the equipment further comprises an additional motor (MII) driving the carriage (C) through part of its movement, and a mechanical switch (A) for switching the carriage drive alternately between the main motor (MI) and the additional motor (MII).

2. The equipment as claimed in claim 1, wherein the disk carriage (C) can move in both directions along an axis substantially perpendicular to the axis of movement of the print head.

3. The equipment as claimed in claim 1, wherein the mechanical switch (A) consists of a gearing system which can pivot between two positions.

4. The equipment as claimed in claim 3, wherein the mechanical switch (A) comprises a right-angle mounted gearing including a gear wheel (11) on the compact disk carriage drive shaft, interacting with an intermediate pinion (5) mounted on an arm (6) pivoting about the shaft of the gear wheel (11).

5. The equipment as claimed in claim 4, wherein the mechanical switch (A) is operated by an actuator (7), a spring (10) being placed between the actuator and the switch.

6. The equipment as claimed in claim 4, wherein the intermediate pinion (5) of the switch (A) is mounted on a shaft which can slide against a spring.

7. The equipment as claimed in claim 1, wherein it comprises a sensor of the movement of the main motor.

8. The equipment as claimed in claim 7, wherein it comprises a control circuit enabling the additional motor to run when the sensor has detected that the main motor is stationary.

9. A method for printing information on the surface of an object, by means of equipment of the type having at least one movable print head and an object carriage and at least one main drive motor, the method comprising placing the object to be printed on the carriage, advancing the carriage by means of an additional motor to a start of print position, advancing the carriage by the main motor during printing, and returning the carriage to its initial position by the additional motor.

10. The method as claimed in claim 9, wherein the additional motor driving the carriage is activated only when the main motor is stationary.

11. The equipment as claimed in claim 5, wherein it comprises a sensor of the movement of the main motor.

12. The equipment as claimed in claim 6, wherein it comprises a sensor of the movement of the main motor.
